(19) United States
(12) Patent Application Publication
(10) Pub. No.: US 2006/0267975 A1
(43) Pub. Date: Nov. 30, 2006

(54) System and method for generating a gemstone proportion graphic

(75) Inventors: Tom Moses, Princeton Junction, NJ (US); Mary Johnson, San Diego, CA (US); Ilene Reinitz, Bayside, NY (US); Al Gilbertson, Murrieta, CA (US); T. Scott Hemphill, Lexington, MA (US); Ronnie Geurts, Antwerp (BE); Kelly Yantzer, Carlsbad, CA (US); Kim Cino, Oceanside, CA (US)

Correspondence Address: DLA PIPER RUDNICK GRAY CARY US LLP, 153 TOWNSEND STREET, SUITE 800, SAN FRANCISCO, CA, 94107-1907, US

(73) Assignee: Gemological Institute of America (GIA)

(21) Appl. No.: 11/084,538

(22) Filed: Mar. 16, 2005

(51) Int. Cl. G06T 1/00; G06T 15/00

(52) U.S. Cl. 345/419; 345/418

(57) ABSTRACT

A system and technique for generating a graphical representation of a gemstone is used to generate a scaled profile view of a gemstone representation. The scaled gemstone graphic includes a first portion that contains scaled graphical representations of facets and a second portion that contains no facets. The gemstone graphic is scaled in accordance with a set of cut proportions obtained for the gemstone representation. The gemstone graphic can be rendered for printing or display in connection with a gemstone grading report.

### FIELD OF THE INVENTION

The present invention relates generally to gemstone evaluation, grading, and measurement. More particularly, the present invention relates to the generation of a graphical representation of a gemstone that depicts a number of gemstone proportions.

### BACKGROUND OF THE INVENTION

The quality of a diamond is often mentioned in connection with its cut, color, clarity, and carat weight (the four C's). In this regard, gem grading laboratories, such as GIA's Gem Laboratory, inspect and grade diamonds in accordance with grading techniques and standards widely accepted in the diamond industry. A grading report is typically prepared for each graded diamond—the report may include cut proportion data, identifying data, and any number of characteristics that indicate the grade of the diamond. For example, a diamond grade report will usually include at least the following information: the shape (e.g., round); the faceting style (e.g., brilliant) the carat weight; the clarity grade; the color grade; cut proportion values or measurements; and the date of the report.

A diamond grading report may also include a diagram or a schematic of the diamond that identifies certain characteristics of the graded diamond, such as the location and size of imperfections, and the overall shape of the diamond. Prior art gemstone graphics and techniques for generating such graphics are typically limited in that they produce somewhat simple diagrams. For example, some prior art gemstone diagrams are not scaled according to the actual proportions, other prior art diagrams do not include descriptors of relevant cut proportions, and other prior art diagrams do not include profile views with facets.

### BRIEF SUMMARY OF THE INVENTION

A gemstone cut proportion graphic generated by the techniques described herein is suitable for use with a gemstone grading report. The graphic is generated in response to certain cut proportions of the gemstone under investigation (which can be a physical gemstone or a computer-generated “virtual” gemstone). In accordance with the invention, the gemstone graphic is a profile view that is scaled in accordance with the cut proportions of the gemstone under investigation. In the example embodiment, only a portion of the profile view contains the gemstone facets. The remaining portion of the profile view contains proportion quantifiers and dimension indicators corresponding to certain cut proportions.

The above and other aspects of the present invention may be carried out in one form by a method for generating a graphical depiction of a gemstone. The method is carried out by obtaining a plurality of proportions for a gemstone representation, and generating a gemstone graphic comprising a profile view of the gemstone representation. The gemstone graphic is scaled according to the plurality of proportions, and the gemstone graphic includes a number of proportion quantifiers corresponding to a number of the proportions.

### BRIEF DESCRIPTION OF THE DRAWINGS

A more complete understanding of the present invention may be derived by referring to the detailed description and claims when considered in conjunction with the following Figures, wherein like reference numbers refer to similar elements throughout the Figures.

FIG. 1 is a schematic representation of an example operating environment for a system for generating a graphical depiction of a gemstone.

FIG. 2 is a schematic representation of a system for generating a graphical depiction of a gemstone;

FIG. 3 is an example gemstone graphic;

FIG. 4 is another example gemstone graphic;

FIG. 5 is an example legend graphic corresponding to the gemstone graphic shown in FIG. 4; and

FIG. 6 is a flow diagram of a gemstone graphic generation process.

### DETAILED DESCRIPTION OF A PREFERRED EMBODIMENT

The present invention may be described herein in terms of functional block components and various processing steps. It should be appreciated that such functional blocks may be realized by any number of hardware, software, and/or firmware components configured to perform the specified functions. For example, the present invention may employ various integrated circuit components, e.g., memory elements, logic elements, look-up tables, and the like, which may carry out a variety of functions under the control of one or more microprocessors or other control devices. In addition, those skilled in the art will appreciate that the present invention may be practiced in conjunction with one or more computer devices, architectures, or networks, and that the system described herein is merely one exemplary application for the invention.

It should be appreciated that the particular implementations shown and described herein are illustrative of the invention and its best mode and are not intended to otherwise limit the scope of the invention in any way. Indeed, for the sake of brevity, conventional techniques for data processing, data transmission, graphical rendering, graphical display, report formatting, gemstone grading, and other aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical embodiment.

The following definitions related to diamond appearance, cut grading, and diamond grade reporting are used herein:

“Cut proportions”—a linear, angular, or relative measurement of one or more physical aspects of a gemstone.

“Gemstone representation”—an actual “real world” or physical gemstone, or a computerized or virtual gemstone that is characterized by appearance, proportion, or other data.

“Proportion quantifier”—a value, number, alphanumeric text, or other identifier that quantifies a cut proportion.

“Proportion descriptor”—alphanumeric text that describes a cut proportion.

The system described herein can be partially or completely computer-implemented. In this regard, the system may be realized in one or more computer devices, which may be connected together in the form of a computer network. The details of computer hardware, network infrastructures, and software architectures are known to those skilled in the relevant arts—such details will not be described herein. Briefly, a computer-implemented system for generating a graphical depiction of a gemstone utilizes one or more computers configured to perform tasks, processes, and procedures described herein (and possibly other tasks).

The graphic generation system may utilize standard desktop, laptop, palmtop, server-based, and/or any suitable computing device or architecture. In this regard, the computing arrangement is suitably configured to perform any number of functions and operations associated with the management, processing, retrieval, and/or delivery of data, and it may be configured to run on any suitable operating system such as Unix, Linux, the Apple Macintosh OS, or any variant of Microsoft Windows. Furthermore, the computing architecture may employ any number of microprocessor devices, e.g., the Pentium family of processors by Intel or the processor devices commercially available from Advanced Micro Devices, IBM, Sun Microsystems, or Motorola.

The computer processors communicate with system memory (e.g., a suitable amount of random access memory), and an appropriate amount of storage or “permanent” memory. The permanent memory may include one or more hard disks, floppy disks, CD-ROM, DVD-ROM, magnetic tape, removable media, solid state memory devices, or combinations thereof. In accordance with known techniques, operating system programs and the application programs associated with the system reside in the permanent memory and portions thereof may be loaded into the system memory during operation. In accordance with the practices of persons skilled in the art of computer programming, the present invention is described below with reference to symbolic representations of operations that may be performed by various computer components, elements, or modules. Such operations are sometimes referred to as being computer-executed, computerized, software-implemented, or computer-implemented. It will be appreciated that operations that are symbolically represented include the manipulation by the various microprocessor devices of electrical signals representing data bits at memory locations in the system memory, as well as other processing of signals. The memory locations where data bits are maintained are physical locations that have particular electrical, magnetic, optical, or organic properties corresponding to the data bits.

When implemented in software, various elements of the present invention are essentially the code segments, computer program elements, or software modules that perform the various tasks. The program or code segments can be stored in a processor-readable medium or transmitted by a computer data signal embodied in a carrier wave over any suitable transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The example embodiment described herein is suitable for use in connection with the grading of round brilliant cut diamonds. The techniques of the invention, however, are not so limited. Indeed, a practical embodiment can be specifically configured to accommodate different types of gems, different cut shapes, and different colored gems. Depending upon the particular application, different cut proportions, different views, and different cut proportion descriptors may be handled by the graphic generation system.

FIG. 1 is a schematic representation of an example operating environment for a system 100 for generating a graphical depiction (i.e., a graphic) of a gemstone under investigation. A significant portion of system 100 is computer-implemented, and, for ease of illustration, system 100 represents a simplified architecture (a practical architecture may have additional and/or alternative physical and logical elements). In this regard, system 100 can be deployed in connection with a conventional computing device, system, or architecture such as a personal computer 102 (for the sake of clarity, conventional elements of the underlying computer architecture are not shown or described in connection with system 100). Personal computer 102 includes one or more user interface components, such as a keyboard 104, a mouse (not shown), a touchpad (not shown), or the like. System 100 includes an electronic display output device, which can be realized as a computer monitor or terminal 106 for personal computer 102. System 100 may also include a printer 108 coupled to personal computer 102, where printer 108 is suitably configured to print documents that contain gemstone graphics as described herein. For example, under the control of personal computer 162, printer 108 can print diamond grading reports that include such gemstone graphics.

In the example embodiment, personal computer 102 is coupled to (or otherwise communicates with) one or more gemstone measuring devices 110. In the context of this description, gemstone measuring device 110 obtains one or more measurements that are useful in generating the gemstone graphic. Gemstone measuring device 110 may also obtain one or more measurements that are useful in preparing a grade for the given gemstone representation. Gemstone measuring device 110 may be configured to automatically transfer the relevant measurement data to personal computer 102 via a suitable communication link 112, which may include one or more physical links and/or one or more wireless links. Alternatively, the measurement data obtained by gemstone measuring device 110 may be transferred to personal computer 102 via a memory storage element such as a CD-ROM, a flash memory card, a magnetic storage disk, or the like. Device 110 can be replaced in system 100 by manual entry (through PC 102) of gemstone characteristics. This versatility may be built into system 100, and also into system 200 which is discussed in detail below.

The specific measurement data gathered by gemstone measurement device 110 can vary from system to system. For example, gemstone measurement device 110 can measure one or more of the following gemstone characteristics: cut proportions (e.g., crown angle, table size), dimensions (e.g., girdle diameter, total depth), and/or calculated weight. Such gemstone measurement devices 110 are known to those skilled in the gemological arts and, therefore, will not be described in detail herein.

FIG. 2 is a schematic representation of a system 200 for generating a graphical depiction of a gemstone. As mentioned above in connection with the description of system 100, system 200 may include one or more gemstone measuring device(s) 202 and a user interface 204 for obtaining gemstone cut proportion and other data from a user. User interface 204 is configured to enter, accept, read, or otherwise receive data or information utilized by system 200. In the practical embodiment, user interface 204 provides gemstone proportion data to system 200. The data may be entered by a user via a keyboard, received in an electronic format by a data reading device, scanned by a suitably configured input device, or the like.

The measured cut proportions, any user-entered cut proportions, and/or any default cut proportions 206 collectively form an initial proportion set 208 for the gemstone representation under investigation. A default cut proportion 206 can be asserted by the user or by system 200 to “lock” or “assume” a value for any particular proportion. For example, it may be desirable to set the culet size or girdle thickness to “medium” for a given set of gemstones. The initial proportion set 208 may be stored in a suitable memory element of personal computer 102 or in a portable memory element (not shown). The initial proportion set 208 may include some or all of the cut proportions necessary for the generation of the gemstone graphic. The initial proportion set 208 need not include all of the necessary cut proportions because some of the cut proportions can be derived or calculated from other known cut proportions. Accordingly, system 200 may perform a proportion derivation routine 210 based on the initial proportion set 208 to generate a final proportion set 212. The final proportion set 212 may be stored in a suitable memory element of personal computer 102 or in a portable memory element (not shown).

In the example embodiment, the final proportion set 212 includes the following cut proportions for a round brilliant cut: crown angle; crown height; pavilion angle; pavilion depth; table size; total depth; star facet length; lower girdle/half facet length; girdle thickness; and culet size. The crown angle and pavilion angle are expressed in degrees. The crown height, pavilion depth, table size, and total depth are relative measurements expressed as a percentage of the average diameter of the gemstone. The star facet length and lower girdle/half facet length are relative measurements expressed as a percentage of the distance from the table edge to the girdle edge and the culet to the girdle edge, respectively. In the example embodiment, girdle thickness is expressed in terms of a descriptive term such as: “extremely thin,” “very thin,” “thin,” :medium,” “slightly thick,” “thick,” “very thick,” or “extremely thick.” Similarly, culet size is expressed in terms of a descriptive term such as: “none,” “very small,” “small,” “medium,” “slightly large,” “large,” “very large,” or “extremely large.” Of course, a given practical embodiment may use a different final proportion set having more or less proportions, the verbal descriptors can vary from that given above, and the proportions themselves can differ depending upon the cut of the gemstone.

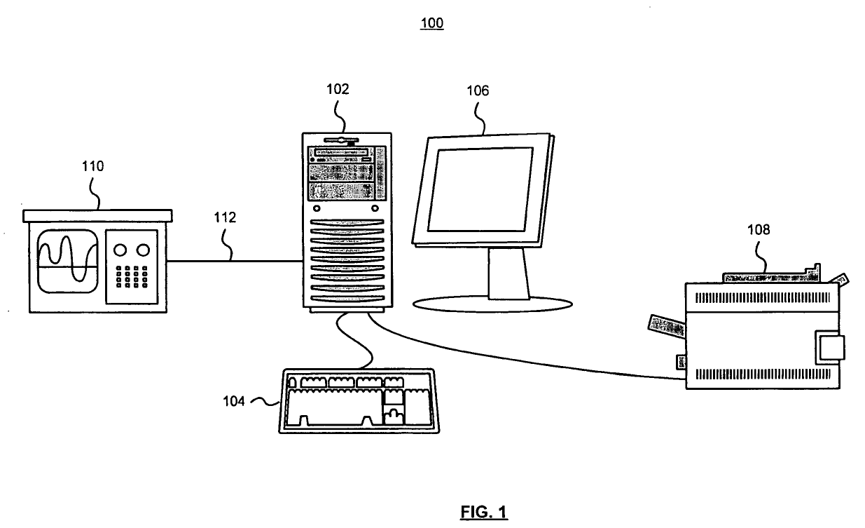

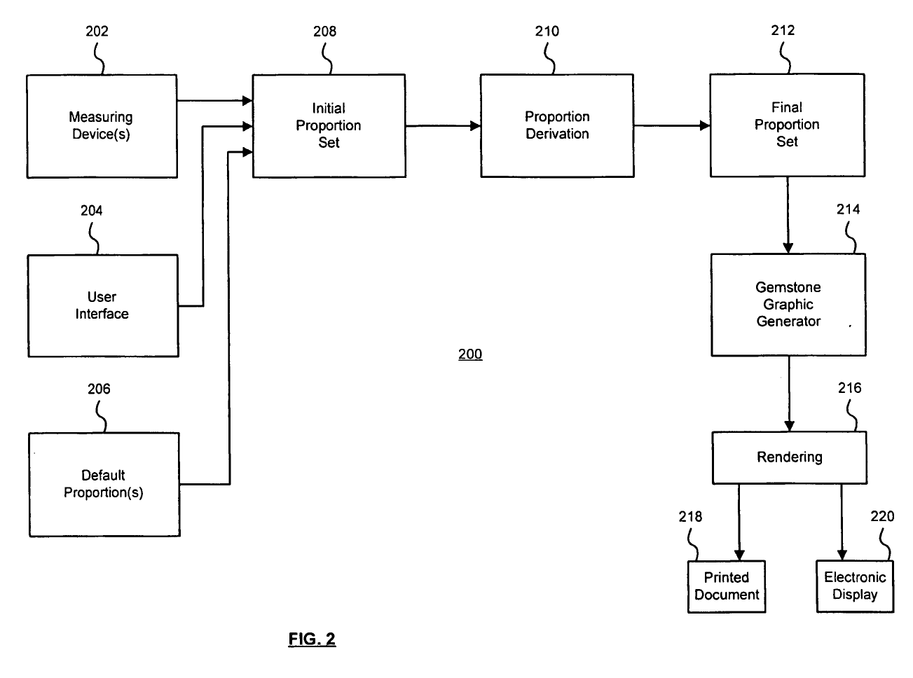

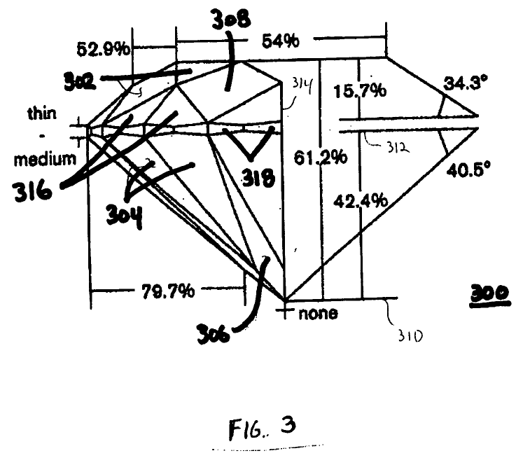

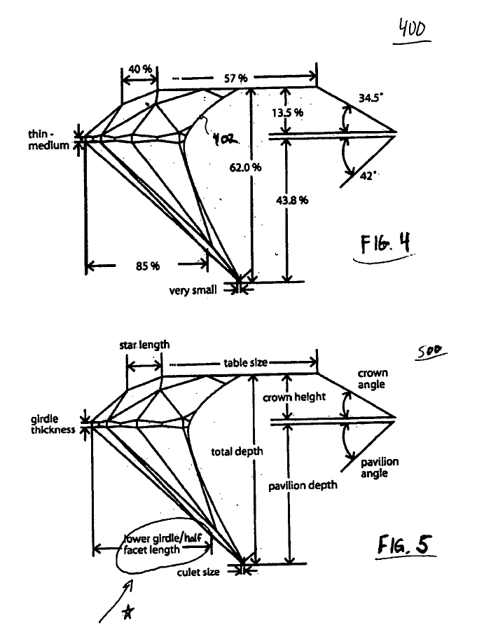

System 200 processes the final proportion set with a gemstone graphic generator 214 that creates, formats, and sizes a gemstone graphic as described in more detail below. In the practical embodiment, graphic generator 214 is coupled to memory elements that store the cut proportions. The graphic generator 214 scales the gemstone graphic according to the cut proportions so that the relative size and positioning of the gemstone facets and the overall outline of the profile accurately reflect the gemstone representation. Example gemstone graphics are shown in FIGS. 3 and 4. System 200 may also include a rendering engine or processor 216 coupled to graphic generator 214. Rendering processor 216 is configured to render the gemstone graphic for presentation in a designated format. Rendering processor 216 may be configured to render the gemstone graphic in any suitable format, including, without limitation: a word processor document; a Portable Document Format (PDF) file; an HTML file; a JPEG image file, a GIF image file, or the like.

In practice, rendering processor 216 may render the gemstone graphic on a printed document 218 (e.g., a diamond grading report) and/or may render the gemstone graphic for electronic display 220 (e.g., for display on a computer monitor). In this regard, printer 108 (see FIG. 1) is suitably coupled to rendering processor 216 via computer 102. Likewise, display terminal 106 is suitably coupled to rendering processor 216 via computer 102. In practice, computer 102 employs a graphics card and drivers compatible with display terminal 106.

FIG. 3 is an example gemstone graphic 300 that can be generated by system 100 or system 200. FIG. 4 depicts an alternate gemstone graphic 400 that may be generated by system 100 or system 200 (the two graphics share many common characteristics and, for the most part, the description of gemstone graphic 300 also applies to gemstone graphic 400). Generally, gemstone graphic 300 comprises a profile side view of the gemstone representation under investigation. Gemstone graphic 300 is scaled according to the cut proportions obtained by the system. In other words, gemstone graphic 300 resembles a scaled version of the actual gemstone representation and gemstone graphic 300 will vary depending upon the particular set of cut proportions.

A first portion of the profile view of gemstone graphic 300 contains graphical representations of facets. In FIG. 3, this portion corresponds to the left side of the profile view. A second portion of the profile view contains no graphical representations of facets. In FIG. 3, this portion corresponds to the right side of the profile view. In the preferred embodiment, graphical representations of facets are contained in only a portion of the gemstone graphic 300, while the remaining portion remains void of facets. For example, the gemstone graphic 300 may include graphical representations of profile views of at least one of the following facets: a star facet 302; a lower girdle/half facet 304; a pavilion main facet 306, a bezel facet 308, an upper girdle facet 316, and girdle facets 318.

Gemstone graphic 300 includes a number of proportion quantifiers corresponding to a number of cut proportions. In FIG. 3, the proportion quantifiers quantify the different cut proportions with specific values, ranges, or relative measures. For example, the proportion quantifier “54%” corresponds to the table size of the gemstone representation, and the proportion quantifier “none” corresponds to the culet size of the gemstone representation. As shown in FIG. 3, gemstone graphic 300 includes ten proportion quantifiers corresponding to ten different cut proportions: a crown angle quantifier (34.3°); a crown height quantifier (15.7%); a pavilion angle quantifier (40.5°); a pavilion depth quantifier (42.4%); a table size quantifier (54%); a total depth quantifier (61.2%); a star facet length quantifier (52.9%); a lower girdle/half facet length quantifier (79.7%); a girdle thickness quantifier (thin-medium); and a culet size quantifier (none). Gemstone graphic 300 may also include a number of dimensional lines or markings corresponding to a number of cut proportions. For example, the boundaries for measurement of pavilion depth are defined by a first dimensional line 310 and a second dimensional line 312. A dimensional line may also correspond to a surface or an edge of a facet. Gemstone graphic 300 may also include one or more dividing lines 314; these lines separate the faceted portion of gemstone graphic 300 from the non-faceted portion. Referring to FIG. 4, gemstone graphic 400 employs a curved dividing line 402 rather than a straight dividing line.

As mentioned above, gemstone graphic 300 is scaled in accordance with the processed cut proportions. For example, the crown angle in gemstone graphic 300 actually measures 34.3°, the pavilion angle in gemstone graphic 300 actually measures 40.5°, and the relative percentage measurements are accurate (all within practical tolerances). Thus, the overall shape, the angular measurements, the individual facet shapes, and the dimensions of the gemstone graphic can vary from one gemstone representation to another.

In FIGS. 3 and 4, only a single thickness is depicted for the girdle facets 318. The girdle thickness would be preferably the thickness of the valleys in this embodiment, which are the thinnest places of the girdle. However, preferably multiple girdle thicknesses are provided, e.g., the thickest and thinnest.

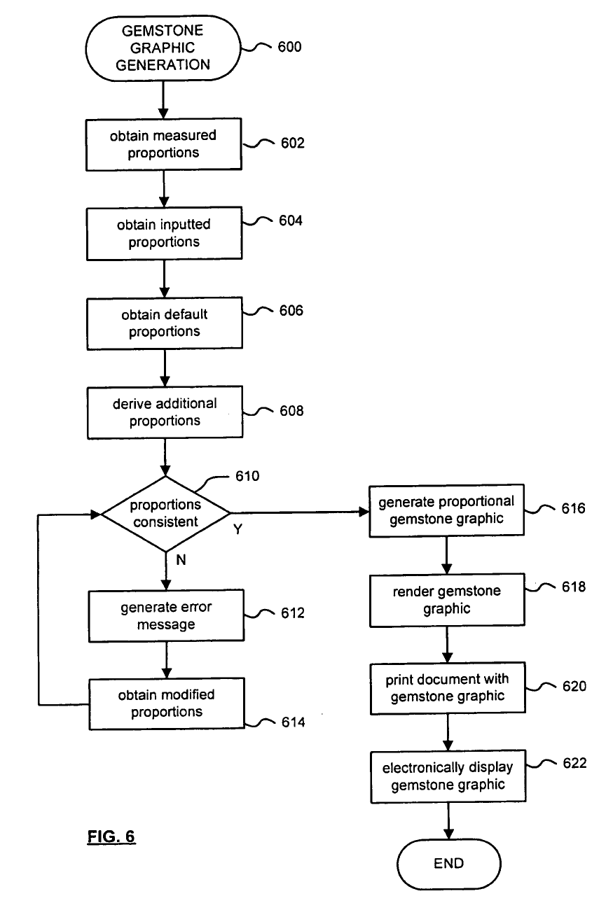

FIG. 5 is an example legend graphic 500 corresponding to the gemstone graphic shown in FIG. 4. Legend graphic 500 shares many of the characteristics of gemstone graphic 300 and portions of the above description of gemstone graphic 300 (and gemstone graphic 400) also apply to legend graphic 500. Gemstone legend graphic 500 is a profile view of a gemstone having the same cut (e.g., round brilliant) as the gemstone representation under investigation. A comparison of FIG. 4 to FIG. 5 clearly shows the similarity between legend graphic 500 and gemstone graphic 400.

In lieu of the proportion quantifiers, legend graphic 500 includes proportion descriptors corresponding to the different cut proportions. As shown in FIG. 5, gemstone legend graphic 500 includes ten proportion descriptors corresponding to ten different cut proportions: a crown angle descriptor (“crown angle”); a crown height descriptor (“crown height”); a pavilion angle descriptor (“pavilion angle”); a pavilion depth descriptor (“pavilion depth”); a table size descriptor (“table size”); a total depth descriptor (“total depth”); a star facet length descriptor (“star length”); a lower girdle/half facet length descriptor (“lower girdle/half facet length”); a girdle thickness descriptor (“girdle thickness”); and a culet size descriptor (“culet size”). In a practical embodiment, the system generates a gemstone grading report that contains both a gemstone graphic and a gemstone legend graphic. The gemstone legend graphic serves as a convenient reference that enables the reader to easily interpret the corresponding gemstone graphic.

In contrast to gemstone graphic 300/400, gemstone legend graphic 500 need not be scaled according to the actual cut proportions. Accordingly, the system can utilize a “fixed” gemstone legend graphic 500 with a scaled gemstone graphic 300/400. Such a fixed legend graphic 500 can be maintained in the system memory for retrieval, rendering, and presentation as necessary.

FIG. 6 is a flow diagram of a gemstone graphic generation process 600 for producing a gemstone graphic as described herein. Referring to the above description, system 100 and system 200 are each suitably configured to carry out process 600. It should be appreciated that the tasks in process 600 need not be performed in the illustrated order and that additional or alternative tasks may be performed in the context of a practical system. Furthermore, process 600 may be performed as part of a more comprehensive process or procedure.

Process 600 begins by obtaining a plurality of proportions for a gemstone representation (which can be either a physical gemstone or a virtual gemstone). An initial set of cut proportions can be obtained from a number of different sources. For example, process 600 can obtain a number of measured proportions for a physical gemstone (task 602) from one or more measurement devices. Alternatively or additionally, process 600 can obtain a number of user-inputted proportions (task 604). Alternatively or additionally, process 600 can obtain a number of default proportions (task 606). Default proportions may be desirable to fix certain proportions for comparative analyses. A practical embodiment need not perform all of tasks 602, 604, and 606, and the initial proportion set may include any suitable number of proportions.

One or more additional proportions can be derived during process 600 (task 608). In this regard, the initial cut proportions are processed to derive the additional proportions. After task 608, process 600 is left with a final set of proportions for the given gemstone representation. In accordance with the example embodiment, the following cut proportions are obtained: crown angle; crown height; pavilion angle; pavilion depth; table size; total depth; star facet length; lower girdle/half facet length; girdle thickness; and culet size.

Process 600 may perform a check to confirm whether the final proportions are consistent (query task 610). In other words, query task 610 determines whether the final proportion set maintains the standard mathematical relationships among the proportions of the standard round brilliant within one tolerance unit for each reported proportion. These relationships include, for example, the correspondence among crown height, crown angle, and table size. If query task 610 determines that the final proportions are inconsistent, then process 600 may generate a suitable error message or indication (task 612) to warn the user. In response to such an error, process 600 may obtain one or more modified proportions (task 614), which can be provided by the user and/or automatically generated by the system. Thereafter, the modified proportions are included in the final proportion set and the final set is again tested for consistency. Thus, process 600 can run iteratively to ensure that a consistent set of proportions are processed. Alternatively, process 600 may simply exit if query task 610 detects an inconsistent set of proportions.

If query task 610 determines that the final set of proportions are consistent, then process 600 proceeds to generate a proportional gemstone graphic (task 616) having the characteristics described above for gemstone graphics 300/400. Briefly summarizing, task 616 generates a scaled profile view of the gemstone representation, where a portion of the profile view contains scaled graphical representations of facets and a portion of the profile view contains no graphical representations of facets. Task 616 also generates a number of proportion quantifiers for the gemstone graphic, along with suitably positioned dimensional lines.

The gemstone graphic is rendered (task 618) for presentation in an appropriate manner. Task 618 may employ different techniques depending upon the rendered format of the gemstone graphic. For example, task 618 may suitably render the gemstone graphic for printing on a document (task 620) such as a grading report, and/or suitably render the gemstone graphic for electronic display (task 622) on a computer monitor. In addition to the rendering of the gemstone graphic, process 600 may generate and render a gemstone legend graphic as described above in connection with FIG. 5. In practice, process 600 prints and/or displays the gemstone legend graphic with the gemstone graphic.

The present invention has been described above with reference to a preferred embodiment. However, those skilled in the art having read this disclosure will recognize that changes and modifications may be made to the preferred embodiment without departing from the scope of the present invention. These and other changes or modifications are intended to be included within the scope of the present invention, as expressed in the following claims.

What is claimed is:

1. A method for generating a graphical depiction of a gemstone, said method comprising:
obtaining a plurality of proportions for a gemstone representation; and
generating a gemstone graphic comprising a profile view of said gemstone representation, said gemstone graphic being scaled according to said plurality of proportions, and said gemstone graphic including a number of proportion quantifiers corresponding to a number of said proportions.

2. A method according to claim 1, further comprising rendering said gemstone graphic for presentation.

3. A method according to claim 2, further comprising generating a gemstone report containing said gemstone graphic.

4. A method according to claim 2, further comprising displaying said gemstone graphic in an electronic format.

5. A method according to claim 1, wherein obtaining a plurality of cut proportions comprises obtaining at least one of the following cut proportions: crown angle; crown height; pavilion angle; pavilion depth; table size; total depth; star facet length; lower girdle/half facet length; girdle thickness; and culet size.

6. A method according to claim 1, wherein generating a gemstone graphic comprises generating at least one of the following proportion quantifiers: a crown angle quantifier; a crown height quantifier; a pavilion angle quantifier; a pavilion depth quantifier; a table size quantifier; a total depth quantifier; a star facet length quantifier; a lower girdle/half facet length quantifier; a girdle thickness quantifier; and a culet size quantifier.

7. A method according to claim 1, wherein generating a gemstone graphic comprises generating graphical representations of facets contained in at least a portion of said profile view.

8. A method according to claim 7, wherein generating a gemstone graphic comprises generating said profile view such that at least a portion of said profile view contains no graphical representations of facets.

9. A method according to claim 1, wherein:
said gemstone representation is a physical gemstone; and
said method further comprises measuring at least one of said plurality of proportions for said physical gemstone.

10. The method of claim 1, further comprising testing a consistency of said proportions.

11. The method of claim 10, wherein said consistency testing comprises iterating for ensuring that consistent proportions are processed.

12. The method of claim 10, further comprising exiting when an inconsistency of said proportions is detected.

13. A method for generating a gemstone grading report, said method comprising:
obtaining a plurality of proportions for a gemstone representation;
generating a gemstone graphic of said gemstone representation, said gemstone graphic comprising a profile view of said gemstone representation, graphical representations of facets contained in only a portion of said profile view, and a number of proportion quantifiers corresponding to a number of said proportions; and rendering a grading report for said gemstone representation, said grading report comprising said gemstone graphic.

14. A method according to claim 13, further comprising printing said grading report.

15. A method according to claim 13, further comprising displaying said grading report in an electronic format.

16. A method according to claim 13, wherein generating a gemstone graphic comprises scaling said profile view according to said plurality of proportions.

17. A method according to claim 13, wherein generating a gemstone graphic comprises scaling said graphical representations of facets according to said plurality of proportions.

18. A method according to claim 13, wherein obtaining a plurality of cut proportions comprises obtaining at least one of the following cut proportions: crown angle; crown height; pavilion angle; pavilion depth; table size; total depth; star facet length; lower girdle/half facet length; girdle thickness; and culet size.

19. A method according to claim 13, wherein generating a gemstone graphic comprises generating at least one of the following proportion quantifiers: a crown angle quantifier; a crown height quantifier; a pavilion angle quantifier; a pavilion depth quantifier; a table size quantifier; a total depth quantifier; a star facet length quantifier; a lower girdle/half facet length quantifier; a girdle thickness quantifier; and a culet size quantifier.

20. A method according to claim 13, wherein generating a gemstone graphic generates graphical representations of profile views of at least one of the following facets: a star facet; a pavilion facet; a lower girdle/half facet; a bezel/main facet; an upper girdle/half facet; and a girdle facet.

21. The method of claim 13, further comprising testing a consistency of said proportions.

22. The method of claim 21, wherein said consistency testing comprises iterating for ensuring that consistent proportions are processed.

23. The method of claim 21, further comprising exiting when an inconsistency of said proportions is detected.

24. A method for generating a graphical depiction of a gemstone, said method comprising:
obtaining a plurality of proportions for a gemstone representation;
generating a gemstone graphic of said gemstone representation, said gemstone graphic being scaled according to said plurality of proportions, and said gemstone graphic comprising a first profile view of said gemstone representation, first graphical representations of facets contained in only a portion of said first profile view, and a number of proportion quantifiers corresponding to a number of said proportions; and
generating a gemstone legend graphic for said gemstone graphic, said gemstone legend graphic comprising a second profile view of a gemstone having the same shape or faceting style, or both, as said gemstone representation, second graphical representations of facets contained in only a portion of said second profile view, and a number of proportion descriptors corresponding to a number of said proportions.

25. A method according to claim 24, further comprising rendering said gemstone graphic and said gemstone legend graphic for presentation.

26. A method according to claim 25, further comprising printing a document containing said gemstone graphic and said gemstone legend graphic.

27. A method according to claim 25, further comprising displaying said gemstone graphic and said gemstone legend graphic in an electronic format.

28. A method according to claim 24, wherein obtaining a plurality of cut proportions comprises obtaining at least one of the following cut proportions: crown angle; crown height; pavilion angle; pavilion depth; table size; total depth; star facet length; lower girdle/half facet length; girdle thickness; and culet size.

29. A method according to claim 24, wherein generating a gemstone graphic comprises generating at least one of the following proportion quantifiers: a crown angle quantifier; a crown height quantifier; a pavilion angle quantifier; a pavilion depth quantifier; a table size quantifier; a total depth quantifier; a star facet length quantifier; a lower girdle/half facet length quantifier; a girdle thickness quantifier; and a culet size quantifier.

30. A method according to claim 24, wherein generating a gemstone legend graphic comprises generating at least one of the following proportion descriptors: a crown angle descriptor; a crown height descriptor; a pavilion angle descriptor; a pavilion depth descriptor; a table size descriptor; a total depth descriptor; a star facet length descriptor; a lower girdle/half facet length descriptor; a girdle thickness descriptor; and a culet size descriptor.

31. The method of claim 24, further comprising testing a consistency of said proportions.

32. The method of claim 31, wherein said consistency testing comprises iterating for ensuring that consistent proportions are processed.

33. The method of claim 31, further comprising exiting when an inconsistency of said proportions is detected.

34. A system for generating a graphical depiction of a gemstone, said system comprising:
memory for storing a plurality of proportions for a gemstone representation;
a gemstone graphic generator coupled to said memory and configured to generate a gemstone graphic of said gemstone representation, said gemstone graphic being scaled according to said plurality of proportions, and said gemstone graphic comprising a first profile view of said gemstone representation, first graphical representations of facets contained in only a portion of said first profile view, and a number of proportion quantifiers corresponding to a number of said proportions; and
a rendering processor coupled to said gemstone graphic generator and configured to render said gemstone graphic for presentation.

35. A system according to claim 34, further comprising a printer coupled to said rendering processor and configured to print said gemstone graphic onto a document.

36. A system according to claim 34, further comprising a display terminal coupled to said rendering processor and configured to display said gemstone graphic in an electronic format.

37. A system for generating a graphical depiction of a gemstone, said system comprising:
means for obtaining a plurality of proportions for a gemstone representation; and
means for generating a gemstone graphic comprising a profile view of said gemstone representation, said gemstone graphic being scaled according to said plurality of proportions, and said gemstone graphic including a number of proportion quantifiers corresponding to a number of said proportions.

38. The system of claim 37, further comprising means for testing a consistency of said proportions.
